(19) United States
(12) Patent Application Publication
(10) Pub. No.: US 2006/0047587 A1
(43) Pub. Date: Mar. 2, 2006

(54) Facilitating management of parts of products to optimize use of common parts

(75) Inventors: Sudhir M. Desai, Wappingers Falls, NY (US); Denise E. Frey, Rochester, MN (US); James A. O'Connor, Ulster Park, NY (US); Theodore V. Purvin JR., Kingston, NY (US)

Correspondence Address: HESLIN ROTHENBERG FARLEY & MESITI P.C., 5 COLUMBIA CIRCLE, ALBANY, NY, 12203, US

(73) Assignee: International Business Machines Corporation, Armonk, NY (US)

(21) Appl. No.: 10/930,391

(22) Filed: Aug. 31, 2004

(51) Int. Cl. G06F 17/50; A01K 5/02

(52) U.S. Cl. 705/29

(57) ABSTRACT

A list of products is created that includes one or more products to be introduced within a future time interval and for zero or more products to be withdrawn within a future time interval, an indication of a withdrawal time. For multiple products of the list of products, a list of parts used by those products is generated. From that list of parts, information is obtained to manage parts of products. This information includes an indication of those parts that are unique, and thus, may be replaced by common parts.

### TECHNICAL FIELD

This invention relates, in general, to managing parts of products, and in particular, to optimizing use of common parts across a wide array of products.

### BACKGROUND OF THE INVENTION

In designing a product, a determination is made as to the parts that are to be used to create that product. Many factors enter into the decision of which parts to use. These factors include, but are not limited to, the characteristics of the parts, requirements of the product, cost, etc. The parts are selected, and the product is created.

Often, an alternative part may be selected, but is not considered, since it does not exactly meet the design considerations. Thus, even in the same company, two different parts are used for two different products, even when one part is suitable for both products.

By using different parts, complexities and costs are increased. For instance, development costs increase by requiring the design and test of multiple parts. Further, inventory costs and manufacturing carrying charges increase by requiring sufficient stock of both parts, which is based on forecast projections, many of which are faulty. Many other issues arise by carrying unique parts.

Based on the foregoing, a need exists for a capability that facilitates management of parts to optimize the use of common parts. For example, a need exists for a capability that identifies unique parts in an effort to work towards replacing the unique parts with common parts, when applicable.

### SUMMARY OF THE INVENTION

The shortcomings of the prior art are overcome and additional advantages are provided through the provision of a method of facilitating management of parts of products. The method includes, for instance, creating a list of a plurality of products having parts to be managed, the list including one or more products to be introduced within a first future time interval and for zero or more products to be withdrawn within a second future time interval, an indication of a withdrawal time; obtaining for at least multiple products of the plurality of products a list of parts for the at least multiple products; and obtaining from the list of parts information usable in managing parts of products.

In a further embodiment, a method of assessing use of parts in products is provided. The method includes, for instance, analyzing a list of parts for multiple products of a product list, the product list including one or more products to be introduced within a first future time interval and for zero or more products to be withdrawn within a second future time interval an indication of a withdrawal time; and providing one or more reports based on the analysis that indicate one or more parts that are to be phased out.

System and computer program products corresponding to one or more of the above-summarized methods are also described and claimed herein.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts one embodiment of an overview of the logic associated with managing parts of products, in accordance with an aspect of the present invention;

FIG. 2 depicts further details of one embodiment of the logic associated with managing parts of products, in accordance with an aspect of the present invention;

FIG. 3 depicts one embodiment of a pictorial representation of one or more aspects of managing parts of products, in accordance with an aspect of the present invention; and

FIG. 4 depicts one embodiment of a computing environment to facilitate one or more aspects of the present invention.

### BEST MODE FOR CARRYING OUT THE INVENTION

In accordance with an aspect of the present invention, a capability is provided to facilitate management of parts of products. In particular, a technique is provided for optimizing the use of common parts that cross a plurality of products. As one example, a common management system, common processes, common tools and common metrics are used to replace unique product parts with common product parts that may be used across a plurality of products.

The leveraging of common parts is to help reduce overall business costs and improve return on investment. Such a strategy strives to maintain brand-unique features and functions, and thus, the revenue associated with each brand, while leveraging common parts. The use of common parts is a strategy driven by the need to remain profitable in an increasingly competitive marketplace. For example, in the computing industry, as high-performance hardware components, such as memory, hard disk drives (HDDs), and even processors, become more widely available from multiple sources, competitors are able to become lower cost producers. The lower costs and business model efficiency gained through a common parts strategy provide a significant competitive advantage.

Designs, such as server designs, based on common parts have been elusive. There are a number of factors that have made the vision of a common plug-compatible product structure used extensively difficult to realize. For instance, in large companies with multiple parallel development efforts occurring simultaneously across large numbers of designers, on different teams, that are geographically dispersed, it is difficult to design common plug compatible building blocks. Realizing significant hardware commonality is not easy, since it is more difficult and takes more time to design systems that use common parts. Designing a common part that can be used across multiple systems is more work. It requires collaboration with other development teams, at different stages in the design process, working to deliver products with somewhat different requirements on different schedules.

Development teams traditionally have been organized around delivering a specific system on a specific date. Subsystem design teams, I/O card designers, memory designers, mechanical packaging designers, power supply designers, each tends to focus on delivering a specific design that meets a specific set of requirements on an aggressive schedule. Each team's belief that completing its immediate objective on schedule is its highest and best service to the business causes its members to view as unnecessary distractions any requirements for a possible future system for some other brand.

There is a natural tendency to grow server models, features and parts. Marketing and brand teams are measured on revenue. The more features and functions available for them to sell, the more opportunity they have to meet their revenue targets. Designers like to design new things, and the more there is to design the better they like it. Each product development team wants its product to have the optimum set of features and functions. Each brand prefers to fund new development that will generate the best returns. Whatever development expense budget is provided is allocated and used to fund work based on a prioritized set of requirements. There is usually great disappointment expressed by all brands that more funding is not available. There is also much more focus on bringing new products, such as servers, into the business than moving older models out.

Common parts, however, result in an overall reduction in development cost. Development expenses decrease through the reduction of similar brand-unique designs. More common parts reduce both development and test time. Plug compatible common parts, ideally common part numbers, are designed and rigorously tested only for the first product in which they are used.

Common parts reduce part costs since it is possible to order and purchase larger quantities from suppliers. Higher volume purchases translate into lower per-unit costs. The volume of common parts ordered increases as the part is used in more and more server models and machine types. For example, an order of 1,000 units each of five unique but similar power supplies could be replaced by a single order of 5,000 units of a common power supply design, in all likelihood at a reduced per-unit price.

More common parts reduce inventory costs and manufacturing carrying charges by making a company less dependent on the accuracy of machine-type and model sale forecast projections. As more plug-compatible common parts are introduced into designs, the inventory of parts and associated carrying charges are reduced. Inventory turns increase, total on-hand inventory is reduced, scrap is reduced, and the risk of missing end-of-quarter shipments due to unique part constraints and ordering complexity is minimized. To revisit the previous example, assume there are five unique power supply designs (Part-A, Part-B, Part-C, Part-D, Part-E) that can be ordered for each of five servers (Server-A, Server-B, Server-C, Server-D, Server-E). At the end of the quarter, it may be that the actual orders for Server A were weaker than projected, so 100 Part A power supplies remain in inventory. Furthermore, assume in the last few days of the quarter it is determined that the demand for Server-D was much higher than projected. Thus, a rush order of an additional 150 Part-D power supplies at a premium price is placed; however, only 100 of the 150 is able to be obtained on such short notice. This means there were 50 additional orders for Server-D that could have been shipped in the quarter, if not part-constrained with Part-D. If all five power supplies were the same common part, some of the excess 100 of Part-A could have been used to fulfill the orders for Server-D, met demand, and avoided the premium-priced rush order from the supplier.

Fewer, more common parts, also results in fewer quality problems. Significant reductions in the number of unique parts provide the opportunity to do a more thorough job of bringing parts into the business and managing them with the same resources. Fewer unique parts makes it easier and less costly to conduct rigorous design qualifications and testing. This is especially important where subtle differences in operating characteristics of complex electronics can result in intermittent difficult-to-diagnose problems. Fewer more common parts provide more opportunity to second source parts that can be leveraged, if quality problems with a particular supply line arise.

Surprisingly, some of the more intractable hardware commonality challenges have been non-technical in nature. Business considerations such as unique pricing requirements can sometimes be a greater obstacle to plug-compatible common part numbers than technical challenges.

Further, design teams that were previously aligned with a specific brand and were located at different sites exhibited “not-invented-here” problems. Each team is understandably very proud of what it has developed over time, and to many their work represents the best design point for a particular brand. However, a common design that would be adequate for the brand could result in a better overall business position for a company.

In almost all cases in which a common part for use across multiple products is to be designed, there is a non-negligible additional amount of development expense required to create the common design. The money has to be spent up front before savings is realized. This incremental investment typically does not improve the revenue prospect of any brand, so there is reluctance for any of the brand organizations to fund this work.

Further, a brand-unique test schedule makes it difficult to keep a common design truly common. Even though common parts reduce the likelihood of finding new problems in subsequent products, some unique problems may be uncovered. Problems found in later tests that require a change to a part also require other brands that use the part and that have already completed their testing, to retest the part and factor the fix into their product lines. These engineering changes represent additional work and some changes can result in a more costly part that other brands may be reluctant to pick up.

Although there are some obstacles to creating common parts to be used across multiple products, the use of common parts has many advantages, as discussed herein. Thus, a facility is provided to manage parts to optimize the use of common parts. In one or more aspects of the present invention, a management system, including processes, mechanisms, procedures and/or tools, is provided by which large numbers of groups of similar yet unique parts can be managed down to substantially near to the minimum number over time. The ability to measure and then minimize the set of total unique part numbers helps reduce unnecessary complexity and end-to-end overhead costs associated with expenses related to product development, inventory, spare parts stocking, scrap, and engineering change costs, as well as eliminate critical part constraints making it much easier to meet end of quarter and end of year orders.

The management system of the present invention is usable in many scenarios, companies, businesses, etc. to manage parts for various types of products. In one example, the parts are managed for products that are across different brands. As used herein, across brands (or cross-brands) includes across different brands of a particular product line, such as across brands of a server (e.g., an iSeries server, a pSeries, etc.), as well as across different product lines altogether (e.g., a server, a storage unit, etc.).

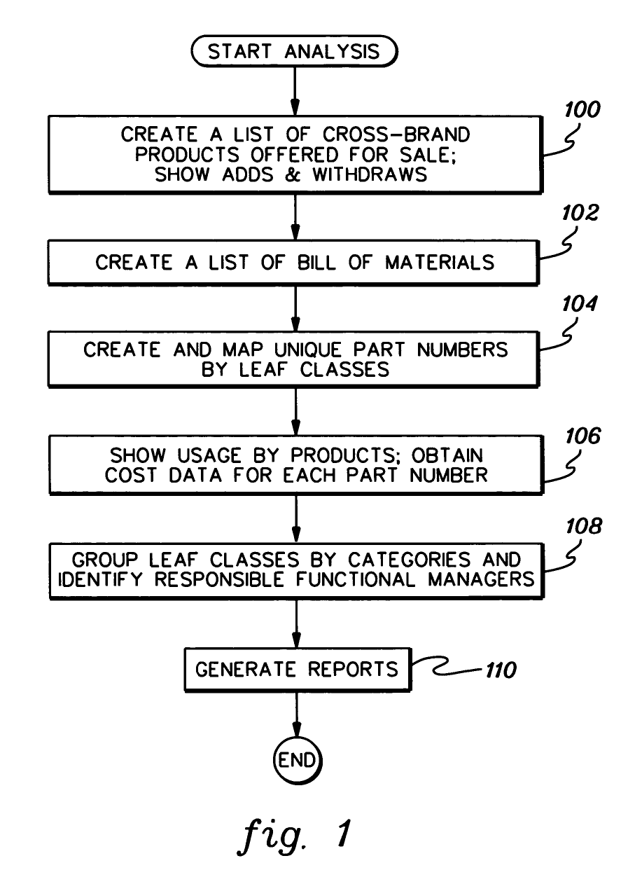

One embodiment of an overview of the logic associated with managing parts of products is described with reference to FIG. 1. Initially, a list of products being offered for sale is created, STEP 100. The list is created by obtaining information from various sources at one or more locations. For instance, for a corporation that has multiple sites, information is gathered from various managers at the multiple sites. In accordance with an aspect of the present invention, this list includes products that are across different brands (e.g., iSeries servers, pSeries servers, zSeries servers, xSeries servers, storage units, etc.). Additionally, in a further aspect of the present invention, the list indicates those products being added within a future time interval, such as by quarters for the next three years, and also an indication of withdrawals for a future time interval, again, such as by quarters for the next three years. The future time intervals for adds and withdrawals may be the same or different. If a product is to be withdrawn within the specified time period, an estimated date of withdrawal is also included. In yet a further embodiment, an estimated date of adding a product is included.

Subsequent to creating the list of products for which parts are to be managed, a bill of materials list is created that includes a detailed list of all parts (or a subset thereof) used by the products of the product list, STEP 102. The part numbers are then grouped into a plurality of groups, referred to as leaf classes, based on one or more selected criteria, STEP 104. For each part number, information is provided, such as the one or more products that use that part number, as well as cost data relating to that part number, STEP 106. Additional or different information may also be provided.

Thereafter, the leaf classes are grouped by categories (e.g., cables, connectors, capacitors, power supplies, ethernet adapters, HDDs, etc.) and one or more functional managers are identified as being responsible for a particular category, STEP 108. Further, one or more reports are generated to assist in managing the parts to optimize use of common parts, STEP 110.

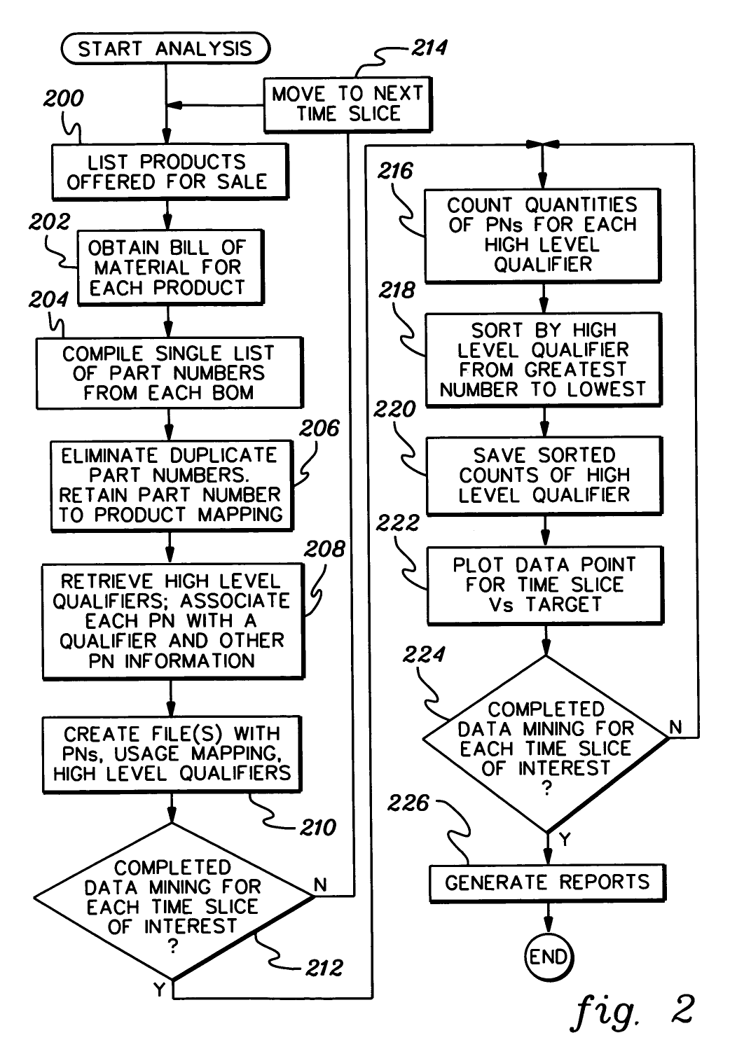

Further details regarding the management process are described with reference to FIG. 2. In one example, the process analyzes data in time slices, such as by quarters, for a determined amount of time, which includes 3-4 years, as one example. The time slices, as well as the determined amount of time, may differ from the example provided herein. There may even only be one time slice in which all the data is considered together. Many other variations exist.

Initially, a list of products currently offered for sale is created, STEP 200. This list includes products within a particular brand and/or across different brands. For example, the list may include iSeries and xSeries servers, as well as storage products and/or a wide array of other products. The list further includes new product planned introductions and planned product withdrawals. The introductions and withdrawals are for specified future time intervals (e.g., 3-4 years), and the interval for introductions may be the same and/or different than the interval for withdrawals. For any withdrawals, an expected date of withdrawal is also provided. Similarly, for introductions, an expected date of introduction is provided. The list is, in one embodiment, a spreadsheet created using Lotus 1-2-3 offered by International Business Machines Corporation, Armonk, N.Y.

Subsequent to creating the list of products for which parts are to be managed, individual bill of materials (BoMs) for current products are obtained to determine the part numbers used in the products, STEP 202. The parts called out in the individual product BoMs are compiled into a complete list of parts for the products, STEP 204. This list of parts establishes the initial base line from which to measure progress. This list includes, for instance, for each product, the part numbers of major subassemblies, as well as component parts, that are used in the subassemblies. The detailed list also includes parts that are expected to be included in new products. An approximate indication of the part numbers to be used for new products is obtained from the engineering team and/or other teams. Also, the approximate indication may be devised from considering the parts of similar products and/or other anaylsis.

From the compiled list of part numbers, any duplicate part numbers are eliminated, STEP 206. However, a mapping of part numbers to products is retained. That is, for each part number in the list, an indication is provided of the one or more products that use that part number.

Thereafter, high level qualifiers, as well as other part number information, are retrieved and associated with the part numbers, STEP 208. For example, high level qualifiers to be used in grouping the part numbers into leaf classes are obtained from one or more databases or created. These qualifiers may have several layers, such as species, family, etc. For instance, one level may be electronic components; a further layer, capacitors; and yet another layer, ceramic capacitors. Each part number is associated with one or more qualifiers, as well as other part number information. The other information is retrieved from one or more databases and/or spreadsheets (such as Lotus 1-2-3 spreadsheets) and includes information like the characteristics of a part number, cost information, etc. One type of database that may be used to store this information is an eXplore database, which is a database in Oracle offered by i2 Technologies, Dallas Tex.

One or more files are created that include the unique part numbers, the mapping of the products to the part numbers and the high level qualifier groupings, STEP 210. These files are used to generate one or more reports, as described in further detail below. An example of a file that is created is a total unique part number (TUPN) list for selected quarters, which may be segmented to allow areas of opportunity for an optimum plug compatible part analysis to be more easily identified by an engineering or other team. As a further example, a TUPN mapping by quarter file is produced to show in which products the particular parts are being used. This file may be sorted in various ways to produce different reports. The file (or report) is used to look at single and limited use part numbers (referred to herein as unique part numbers) to help determine whether a more common part may be used.

These files may be created by various means and/or techniques. In one example, a common building block (CBB) metrics tool based on a Brio Explorer application owned by Hyperion Solutions Corporation, Sunnyvale, Calif., is used to create the files. The tool receives input, maps the data received to particular part numbers and provides output. Input to the tool includes the one or more databases and/or spreadsheets holding the desired information, and the output is exported as, for instance, a Lotus 1-2-3 spreadsheet. In particular, in this embodiment, the metrics tool is used to perform STEPs 202-210 of FIG. 2. In other embodiments, however, one or more other mechanisms may be used to perform one or more of the steps. For example, to perform STEP 204 in which bill of material details are automatically extracted from one or more databases, such as DB2 databases offered by International Business Machines Corporation, Armonk, N.Y., a batch job may be run. Other examples also exist. The use of the metrics tool is only one example.

Subsequent to creating the files, a determination is made as to whether data mining for each time slice of interest is concluded, INQUIRY 212. If not, then a new time slice is selected, STEP 214, and processing continues with STEP 200. However, if data mining for each time slice of interest is complete, then processing continues with a count of the quantities of part numbers for each high level qualifier, STEP 216. For instance, for each high level qualifier, the number of part numbers for that qualifier is determined. Thereafter, a sort is performed by high level qualifier from the greatest number of counts to the lowest number of counts, STEP 218. The sorted counts of high level qualifiers are saved, STEP 220, and a plot is created showing the data for the current time slice versus selected targets, STEP 222. The plot shows, for instance, how the number of parts vary over time and how that compares with established target reductions over time.

A determination is then made as to whether the data mining for each time slice of interest is complete, INQUIRY 224. If not, then processing continues with STEP 216. Otherwise, processing continues with generating desired reports, STEP 226. As one example, many reports may be generated including, but not limited, to a cross-brand total unique part numbers versus target over time report; a cross-brand leaf class counts sorted by greatest number for each part type and time slice report; and a cross-brand part number sorted by leaf class mapped to product where used report.

The cross-brand total unique part numbers versus target over time report is a report that highlights the impact of adds and withdrawals by quarters on fulfillment part number inventories. The report is sent to, for instance, the vice-president of manufacturing.

The cross-brand leaf class counts sorted by greatest number for each part type and time slice report is a report that highlights increases or decreases of part number quantities over time and allows owners to create/manage a roadmap for the part types. It is sent to, for instance, functional manager owners of the part type.

The cross-brand part numbers sorted by leaf class mapped to product where used report highlights usage of each part number in the leaf class and shows the cross-brand products using it. It allows designers to identify low/no reuse parts and plan part substitution for increased re-use. The report is provided to, for instance, design teams for each leaf class.

In addition to the three reports, other reports may be provided, such as specific detailed reports with additional part number information, such as part number characteristics, package types, power levels, length, etc., as needed for each part type design team.

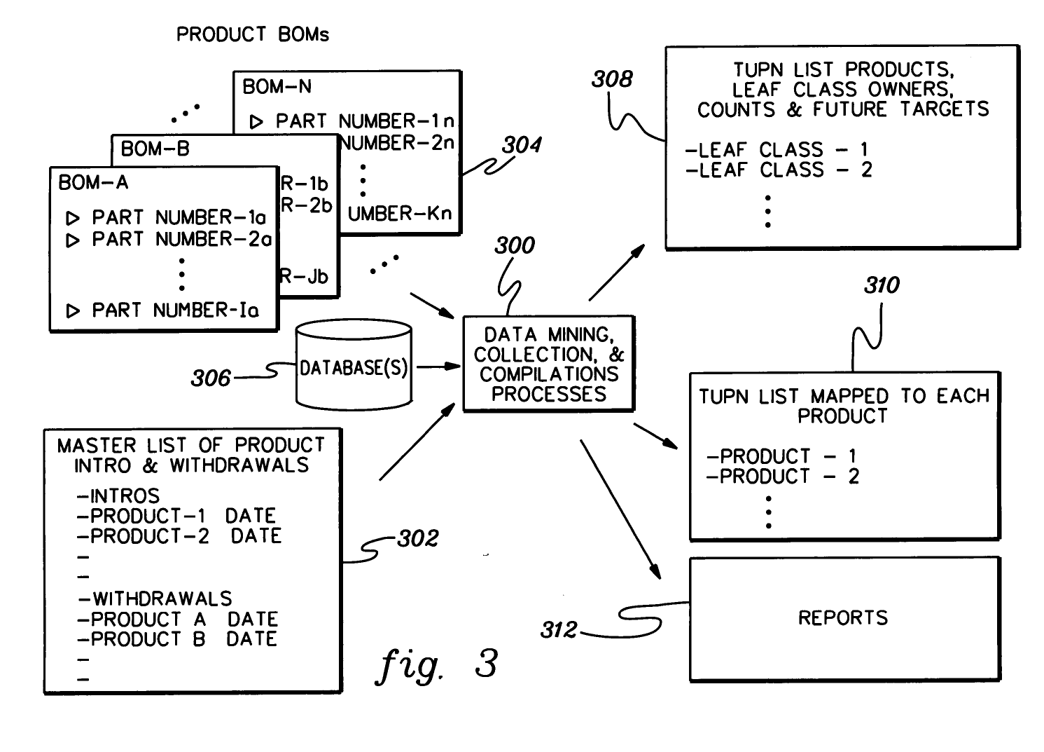

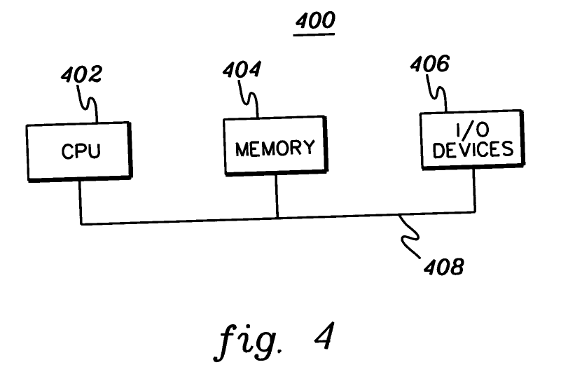

A pictorial representation of the management system is depicted in FIG. 3. As shown, data mining, collection and compilation processes 300 have as inputs a master list of products including introductions and withdrawals 302, individual bill of materials for products 304 and one or more databases 306 that include information associated with the part numbers. Processes 300 use this information to generate one or more files, including but not limited to, a total unique part number (TUPN) list 308 and a TUPN mapping 310, as well as one or more reports 312. The processes may be executed within various computing environments. Further, many types of databases and tools may be used to obtain, manage and/or analyze information relating to part numbers and/or the processes. One example of a computing environment useful in the management facility of the present invention is described with reference to FIG. 4.

In one example, a computing environment 400 includes, for instance, a central processing unit 402, a memory 404 (e.g., main memory) and one or more input/output (I/O) devices 406 coupled to one another via, for example, one or more busses 408. The computing environment may include a server, a personal computer, a mainframe computer, as well as many other types of computing units.

Described in detail above is a capability for facilitating management of parts of products. This management enables optimization of the use of common parts across a wide array of products. The goal is to reduce the number of unique part numbers being used, and instead, to use common parts that can be used in multiple products.

By reducing part numbers through increased reuse, significant business benefits are realized. A common management system, common processes, common tools and common metrics are used to realize this benefit. The tools, processes and organizational structure help guide the design and engineering teams to a more common set of parts. Along with more efficient use of critical development resources, the simplification effort achieves substantial end-to-end cost reductions through efficiencies gained in inventory management, spare parts stocking, scrap, and other processes traditionally dependent on accurate filing forecast for a single machine type and model. This effort also achieves significant improvement in quality by reducing the total number of unique parts, thus reducing opportunities for quality and design problems to arise.

The migration to common parts occurs incrementally. A company should not expect to make the leap to common parts across its entire family of products in a single step. Focus on commonality that will provide the greatest benefit to manufacturing and procurement. Make manufacturing a partner with development in crafting the commonality strategy.

There is to be a focused effort to help drive the various teams to examine and balance the cost side of the equation. Realizing product designs based to a large extent on common parts requires a comprehensive management system and common metrics to help understand and quantify what has been achieved and to guide the organizations to a common goal. There should also be a well-conceived plan to remove processes and infrastructure in manufacturing and fulfillment systems.

The management technique includes creating a comprehensive list of product introductions and withdrawals over time and then extracting data related to specific parts and part types from one or more general parts databases. Part type counts and how they vary over time are used to provide visibility to where unique part numbers proliferate designs. Each part and each part type category are further mapped to prior uses, so that single usage and low usage parts become visible. By evaluating how this data changes over time (products are withdrawn and new products are added to the product portfolio) allows actions to be taken earlier in the design cycle to achieve higher common part usage. This is a structured process to help achieve significant plug compatible parts commonality of large numbers of parts used in a large number of products.

Advantageously, key data and summary reports are provided that help drive product simplification through the use of more common plug compatible parts. Areas of opportunity are made visible to the engineering teams so that detail design considerations can be made early in the process, so that each subassembly can be crafted as a plug compatible common building block usable across different product lines. System components, from the smallest capacitor to the largest power supply, are included in this structure. The detailed data for specific areas of interest and opportunity, like assemblies, such as HDDs, memory, I/O cards, I/O enclosures, processors, and power/mechanical assemblies are segmented and broken out in a way that makes it easy for each design team to understand what still needs to be done and to develop the appropriate strategy for the product under development.

Advantageously, by using this management system, cost savings are realized and complexities are reduced. Keeping total unique part numbers at a minimum helps ensure a more efficient end-to-end cost structure. The use of common parts provides the following: inventory expense reduction; flexibility in manufacturing; order fulfillment flexibility; less sensitivity to parts forecast accuracy; better use of critical design skills; reduction in part costs due to higher volume ordering; reduction in parts stocking costs; reduction in scrap costs; test efficiency and total problem reduction; reductions in support structure and overhead; and reduction in costs due to fewer and more common parts.

Although examples and embodiments are described herein, many variations to these examples and embodiments may be provided and are included within the scope of the present invention. For example, although products, such as servers and storage units, are described herein, parts of many other products may be managed in a similar manner. Further, although the computing industry is mentioned, again many other industries may benefit from one or more aspects of the present invention. Additionally, although specific individuals are designated to receive certain reports, other and/or different individuals may receive those reports. Further, different reports may be generated and used.

In one example, parts are determined for all the products in the list of products. However, in another example, parts may be determined for selected products. Additionally, although the term “list” is used herein, this term does not refer to any particular structure, but just a gathering of information. Yet further, in other examples, additional information may be associated with the part numbers to provide different reports. Any information associated with the part numbers is referred to herein as attributes. The attributes can include, for instance, cost information, part number characteristics, as well as any other desired information. Again, many variations to the above examples and environments may be provided and are considered within the scope of the present invention.

The capabilities of one or more aspects of the present invention can be implemented in software, firmware, hardware or some combination thereof.

One or more aspects of the present invention can be included in an article of manufacture (e.g., one or more computer program products) having, for instance, computer usable media. The media has therein, for instance, computer readable program code means or logic (e.g., instructions, code, commands, etc.) to provide and facilitate the capabilities of the present invention. The article of manufacture can be included as a part of a computer system or sold separately.

Additionally, at least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of facilitating management of parts of products, said method comprising:
creating a list of a plurality of products having parts to be managed, said list comprising one or more products to be introduced within a first future time interval and for zero or more products to be withdrawn within a second future time interval, an indication of a withdrawal time;
obtaining for at least multiple products of the plurality of products a list of parts for the at least multiple products; and
obtaining from the list of parts information usable in managing parts of products.

2. The method of claim 1, wherein the information includes an indication of one or more parts that are considered unique.

3. The method of claim 1, wherein the list of the plurality of products comprises one or more products from a first brand of products and one or more products from a second brand of products.

4. The method of claim 1, further comprising selecting from the list of parts a part to be used in a product, said part being a common part.

5. The method of claim 1, wherein at least one future time interval of the first future time interval and the second future time interval comprises multiple years.

6. The method of claim 1, further comprising repeating said creating, said obtaining the list of parts and said obtaining the information at specified time intervals.

7. The method of claim 1, further comprising providing cost data for at least a portion of the parts of the list of parts.

8. The method of claim 1, further comprising grouping the list of parts into a plurality of groups based on one or more selected qualifiers, wherein group information regarding one or more groups is obtainable.

9. The method of claim 8, wherein group information for a group comprises a count of unique parts of the group.

10. The method of claim 8, further comprising mapping a unique part of a group to one or more products that use that unique part.

11. The method of claim 1, further comprising associating with one or more parts of the list of parts one or more part attributes.

12. A method of assessing use of parts in products, said method comprising:
analyzing a list of parts for multiple products of a product list, said product list including one or more products to be introduced within a first future time interval and for zero or more products to be withdrawn within a second future time interval an indication of a withdrawal time; and
providing one or more reports based on the analysis that indicate one or more parts that are to be phased out.

13. A system of facilitating management of parts of products, said system comprising:
a list of a plurality of products having parts to be managed, said list comprising one or more products to be introduced within a first future time interval and for zero or more products to be withdrawn within a second future time interval, an indication of a withdrawal time;
means for obtaining for at least multiple products of the plurality of products a list of parts for the at least multiple products; and
means for obtaining from the list of parts information usable in managing parts of products.

14. The system of claim 13, wherein the information includes an indication of one or more parts that are considered unique.

15. The system of claim 13, wherein the list of the plurality of products comprises one or more products from a first brand of products and one or more products from a second brand of products.

16. The system of claim 13, further comprising means for grouping the list of parts into a plurality of groups based on one or more selected qualifiers, wherein group information regarding one or more groups is obtainable.

17. The system of claim 16, further comprising means for mapping a unique part of a group to one or more products that use that unique part.

18. The system of claim 13, further comprising means for associating with one or more parts of the list of parts one or more part attributes.

19. An article of manufacture comprising:
at least one computer usable medium having computer readable program code logic to manage parts of products, the computer readable program code logic comprising:
create logic to create a list of a plurality of products having parts to be managed, said list comprising one or more products to be introduced within a first future time interval and for zero or more products to be withdrawn within a second future time interval, an indication of a withdrawal time;
obtain logic to obtain for at least multiple products of the plurality of products a list of parts for the at least multiple products; and
obtain logic to obtain from the list of parts information usable in managing parts of products.

20. The article of manufacture of claim 19, further comprising group logic to group the list of parts into a plurality of groups based on one or more selected qualifiers, wherein group information regarding one or more groups is obtainable.
